(19) United States
(12) Patent Application Publication
(10) Pub. No.: US 2025/0335964 A1
(43) Pub. Date: Oct. 30, 2025

(54) PERSONA-BASED CONTENT RENDERING

(71) Applicant: NCR Voyix Corporation, Atlanta, GA (US)

(72) Inventors: Kip Oliver Morgan, Atlanta, GA (US); Nannapuraju Dheeraj Raju, Hyderabad (IN); Gina Torcivia Bennett, Lawrenceville, GA (US); John Kennedy, Atlanta, GA (US)

(21) Appl. No.: 18/651,175

(22) Filed: Apr. 30, 2024

(51) Int. Cl. G06Q 30/0601; G06F 16/735

(52) U.S. Cl. CPC G06Q 30/0631; G06F 16/735

(57) ABSTRACT

Videos depicting products are analyzed to uniquely identify the products by frame within each video and to uniquely identify non-product objects by frame within each video. Based on the analysis each video is tagged with product codes and non-product identifiers. Based on the non-product identifiers, each video is further classified by persona. During a checkout of a customer, a recommendation service provides recommended products that the customer is believed to be interested in purchasing. The recommended products and known personas of the customer are used to generate a video playlist for the checkout, each video including at least one of the recommended products presented within the video in a known persona context. A video from the playlist is selected and played within a screen on a display to the customer during the checkout. The screen is a screen not being used by a transaction user interface for the checkout.

### BACKGROUND

Content rendered to customers at checkout terminals may not be tailored or relevant to the customers. Because of the impersonal nature of such content, few additional sales occur at checkout beyond a customer's initially selected items.

### BRIEF DESCRIPTION OF THE DRAWINGS

FIG. 1A is a diagram of a system for persona-based content rendering to a customer during a checkout, according to an example embodiment.

FIG. 1B is an entity relationship diagram for persona-based content rendering to a customer during a checkout, according to an example embodiment.

FIG. 1C is a graphic depicting persona-based content rendering during a checkout, according to an embodiment.

FIG. 2 is a flow diagram of a method for persona-based content rendering to a customer during a checkout, according to an example embodiment.

FIG. 3 is a flow diagram of another method for persona-based content rendering to a customer during a checkout, according to an example embodiment.

### DETAILED DESCRIPTION

Customized content rendering to customers during checkouts is challenging. Many user interfaces (UIs) provide space and features for rendering separate content during a user session. This capability, however, is not being leveraged effectively in the retail industry, as evidenced by the low conversion rates of customers purchasing additional products during checkouts. Current approaches largely provide impersonal and irrelevant content to customers during checkouts, which often irritates customers and ensures low conversion rates.

The above technical issues are solved by the technical solutions provided herein and below. According to example embodiments of the technology disclosed herein, video content is preprocessed to identify products and objects presented in the videos. A histogram of product codes and object identifiers for each video is then created from the identified products and objects of each video. Predefined personas are established and mapped to the videos using the histograms. Customer loyalty profiles including affirmative likes and dislikes are also mapped to the personas. During a transaction, a customer is identified either biometrically or through customer-provided information and a product catalog for the products of a given store associated with the transaction and the customer's loyalty profile is provided to a product recommendation service. The product recommendation service returns product codes that the service believes the customer is likely to consider adding to their checkout. The recommended product codes are matched to the customer's persona and video content having the product codes within the context of the customer's persona is played within screens of the transaction UI during the checkout. The video content rendered is specifically tailored to the customer and the products presented are specifically provided by the product recommendation service. In an embodiment, the video content includes a link for each product presented within the UI for the customer to select and add to their checkout. In an embodiment, buttons to add each product are shown below the video content being played.

As used herein a “customer,” a “consumer, and a “user” may be used interchangeably and synonymously. This is an individual that is checking out with one or more items, products, goods, or services with a retailer or a store of a retailer using a transaction UI of the retailer on a transaction terminal or a user device.

“Content” refers to video, graphics, text, images, presentations, or combinations thereof. The content includes products which the retailer is attempting a customer to add to their existing transaction during a checkout. The products are presented and played within a context and/or theme related to a persona. For example, video content for a soda product includes dogs for a dog lover persona, includes a sporting event for a sport enthusiast persona, includes flowers or plants for a gardener enthusiast, etc.

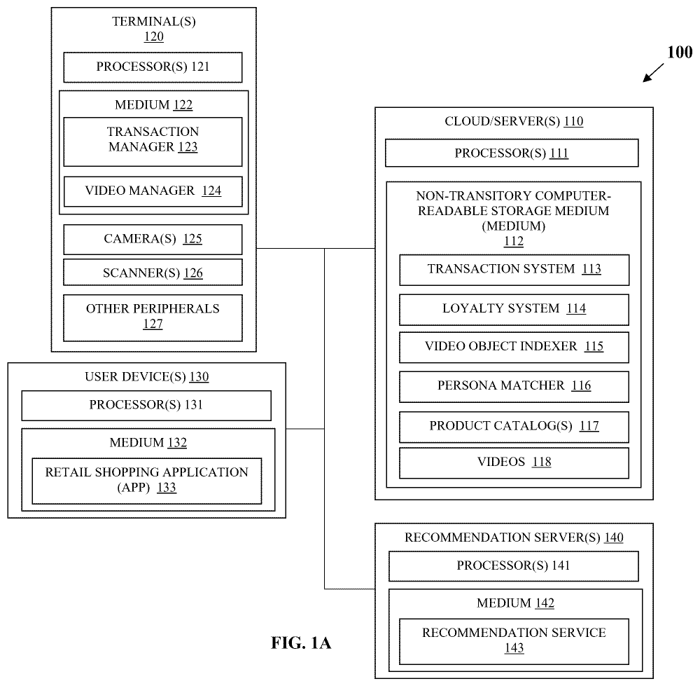

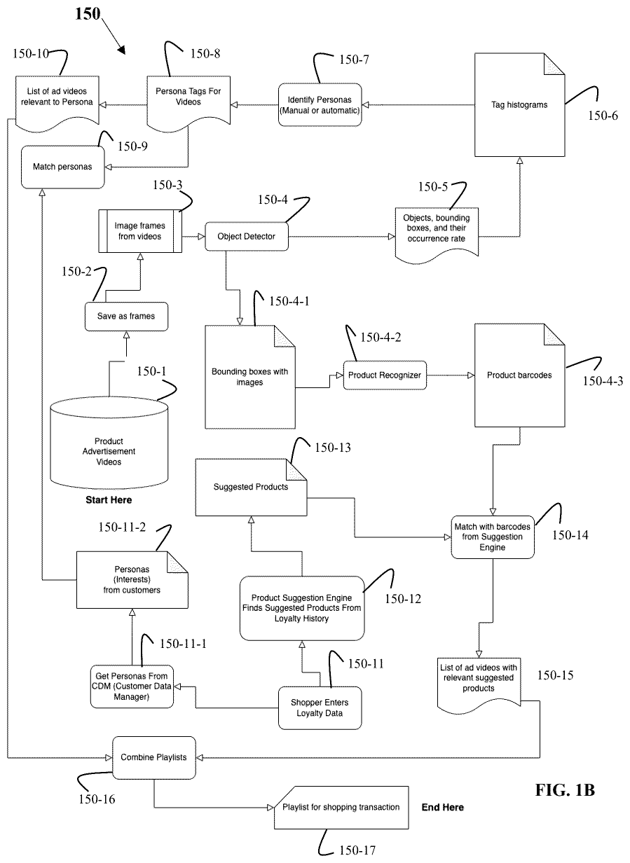

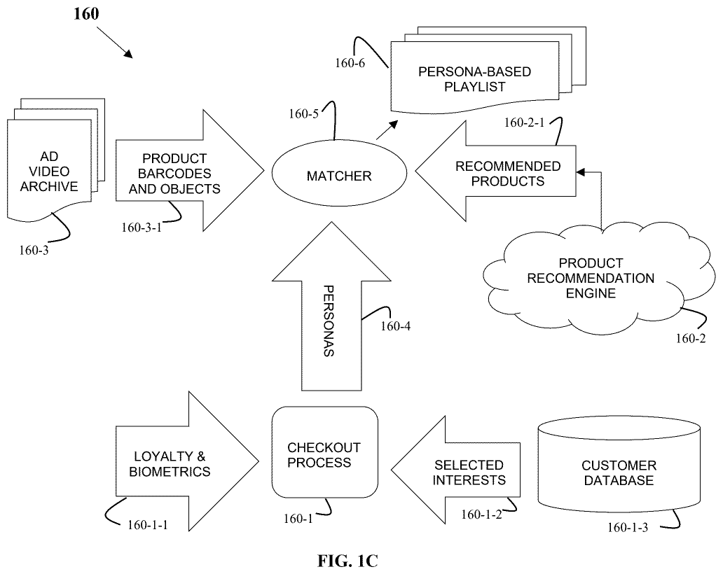

FIG. 1A is a diagram of a system 100 for persona-based content rendering to a customer during a checkout, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings of persona-based content rendering to a customer during a checkout, presented herein and below.

System 100 includes a cloud/server 110 (hereinafter just “cloud 110”), one or more terminals 120, one or more user devices 130, and one or more recommendation servers 140. Cloud 110 includes at least one processor 111 and a non-transitory computer-readable storage medium (hereinafter just “medium”) 112, which includes instructions for a transaction system 113, a loyalty system 114, a video object indexer 115, and a persona matcher 116. The instructions when provided to and executed by processor 111 cause processor 111 to perform the processing or operations discussed herein and below with respect to 113-116. Medium 112 also includes one or more product catalogs 117 and videos 118; both of which are at least accessible to video object indexer 115 and persona matcher 116.

Each terminal 120 includes at least one processor 121 and a medium 122, which includes instructions for a transaction manager 123 and, optionally, a video manager 124. The instructions when provided to and executed by processor 121 cause processor 121 to perform the processing or operations discussed herein and below with respect to 123 and/or 124. The terminal 120 also includes one or more cameras 125, one or more scanners 126, and other peripherals 127, such as a card reader, a weigh scale, a baggage scale, a touch display, a media depository acceptor, a media depository dispenser, a keypad, wireless transceivers, etc.

Each user device 130 includes at least one processor 131 and a medium 132, which includes instructions for a retail shopping application (app) 133. The instructions when provided to and executed by processor 131 cause processor 131 to perform the processing or operations discussed herein and below with respect to 133.

Each recommendation server 140 includes at least one processor 141 and a medium 142, which includes instructions for a recommendation service 143. The instructions when provided to and executed by processor 141 cause processor 141 to perform the processing or operations discussed herein and below with respect to 143.

Initially, video object indexer 115 analyzes videos 118 for purposes of identifying product or item objects and other objects recognized in the frames of each video. By way of example only, other objects include types of human faces, types of animals, types of pets, types of containers, types of furniture, types of food, ice, water, glasses, packages, types of cars, types of trucks, types of boats, airplanes, bicycles, electronic devices, types of exercise equipment, types of sports equipment, famous individuals, types of venues, beaches, waterways, mountains, forests, etc. In an embodiment, the objects are assigned unique identifiers or names (i.e., descriptive words), the products recognized are assigned a global trade identification number (GTIN) mapped to a descriptive product or item. The frequencies with which each product and or object appears from frame to frame within a given video 118 is noted in a histogram. A given histogram for a corresponding video 118 being analyzed includes each unique GTIN, each unique object, and a corresponding frame frequency count for each unique GTIN and each unique object.

In an embodiment, video indexer 115 analyzes each video 118 to produce two separate and distinct histograms per video 118. A first histogram is for the GTINs recognized in the frames of the corresponding video 119. The second histogram is for the non-GTIN objects recognized in the frames of the corresponding video 119.

In an embodiment, video object indexer 115 provides each video 118 as input to a machine learning model and receives as output the corresponding histogram for the video 118. That is, the machine learning model performs object recognition on the video 118 and maps the objects identified to either a GTIN (e.g., product or item code) or an object tag or identifier and outputs the histogram. The video object indexer 115 maps the output from the model for the GTINs and the object tags/identifiers into descriptive words in readable text.

In an embodiment, video object indexer 115 utilizes a third-party or off-the-shelf product recognizer, which identifies the product objects and assigns the GTINs to the products. For example, video object indexer 115 uses Vertex AI Vision® by Google Cloud® to process frames of the video 118, identify product objects, and assign GTINs to each product object identified.

In an embodiment, video object indexer 115 uses a hybrid approach that includes its own machine-learning product object recognition and a third-party off-the-shelf product recognizer. A machine learning model provides for coarse grain product object recognition for products of the video 118 and the third-party product recognizer takes the coarse grain product object image as input from the model and provides as output a corresponding GTIN or product identifier each the product.

Next, persona matcher 116 uses the histogram associated with each video and predefined personas to determine one or more unique persona tags to associate with each video 118. That is, a single video 118 can be associated with a single persona or with two or more personas.

In an embodiment, persona matcher 116 provides each histogram and/or each corresponding video 118 as input to a machine learning model. The machine learning model maps one or more predefined personas to the corresponding histogram and/or video 118.

In an embodiment, persona matcher 116 includes a UI that permits an analyst to view each video 118 along with the descriptive information for the GTINs and other objects from the corresponding histogram(s). The analyst also views within the UI a list of predefined personas and assigns one or more of the predefined personas to each video 118. In an embodiment, an option within the UI permits the analyst to add a new persona to the list of presented predefined personas. In an embodiment, a machine learning model is trained on the histograms, videos 118, and assigned personas by the analysts to output the one or more personas on new and different videos based on the corresponding video 118 and corresponding histogram(s). In this way, the manual analysis of the analyst can be completely eliminated once the model produces a threshold accuracy metric in predicting persona(s) based on new videos 118 and their corresponding histograms. In an embodiment, a feedback training loop is established such that the analyst can produce new training data for the model when the model predicts incorrect personas for videos 118. In this way, the model's accuracy metric is continuously improved over time.

In an embodiment, persona matcher 116 uses a heuristic and rules-based approach and scores each histogram associated with non-GTINs to assign one or more personas to each video 118. For example, each predefined persona is associated with a threshold score based on one or more specific object tags being present in a certain number of frames in a given histogram associated with a given video 118. Persona matcher 116 processes the rules using the corresponding histogram to assign each predefined persona its own score, which is then compared against a persona-specific threshold value to determine if the corresponding video 118 should or should not be associated and linked to the corresponding persona.

Once, the videos 118 are analyzed for the product objects and/or codes (i.e., GTINs) and other objects associated with one or more personas based on the corresponding histograms, system 100 is prepared to provided persona-based and product-specific based content rendering to customers during transactions with a retailer. This is done in a variety of manners described below.

A given loyalty system 114 for a given retailer includes a customer profile, which includes the customer's transaction history of products or items, customer likes, and customer dislikes. A UI to the loyalty system 114 permits the user to explicitly express likes and dislikes relevant to known personas and products or items. For example, a user indicates that they love yogurt, dogs, beaches, mountains, oceans, cars, etc.; the same user also indicates that they dislike alcohol, soda, violence, big cities, cats, etc.

Persona matcher 116 builds video playlists for the customers based on each customer's likes and dislikes. In an embodiment, a link to the playlist. perhaps indexed by product, is maintained as a field in a loyalty record of the corresponding loyalty system 114 associated with each customer of a given retailer.

During a checkout process (herein above and below just “checkout”), a customer has initiated a transaction with products to be purchased. The transaction is initiated on a terminal 120 in the situation where the customer is checking out via an in-store terminal 120 or the transaction is initiated on a user device 130 in the situation where the user is shopping online or shopping in-store via the user's device 130.

The transaction manager 123 or the retail shopping app 133 receives identifying information from the customer who initiated the transaction for the checkout via terminal 120 or user device 130. The identifying information permits the customer to be linked to a loyalty account of a loyalty system 114 for a given retailer.

In an embodiment, the identifying information is a loyalty card scanned by a scanner 126, captured by camera 125, or a camera of user device 130. In an embodiment, the loyalty card is swiped by a cart reader (e.g., other peripheral 127) of terminal 120. In an embodiment, the customer enters a loyalty account number or identifier using a touch display (e.g., other peripheral 127) of terminal 120 or using a touch display of user device 130. In an embodiment, the identifying information is an image of a face of the customer captured by a camera 125 of terminal 120 or a camera of user device 130. In the case where the identifying information is an image of the customer's face, the transaction manager 123 or retail shopping app 133 passes the facial image to transaction system 113 or persona matcher 116 where features of the facial image are hashed and a hash value searched for in the loyalty system 114 to obtain a loyalty account, corresponding customer identity for the customer, and corresponding loyalty profile of the customer linked to the loyalty account.

As soon as the loyalty profile is obtained, persona matcher 116 retrieves the video playlist linked to the customer's loyalty account. Concurrently or simultaneously, transaction system 113 passes a product catalog 117 and loyalty profile of the customer to a given recommendation service 143 for purposes of receiving back one or more product codes from the product catalog that the customer is believed likely to purchase with their transaction based at least on the transaction history of the customer retained in the customer's loyalty profile.

The selected recommendation service 143 returns the product codes back to transaction system 113. Transaction system 113 provides to transaction manager 123 or retail shopping app 133 for purposes of suggesting to the customer these additional products associated with the product codes during checkout. The suggested product codes are also provided to persona matcher 116. Persona matcher 116 filters the video playlist retained the customer on the suggested product codes and generates a subset of the video playlist. Persona matcher 116 provides the subset of the video playlist to video manager 124. Video manager 124 or retail shopping app 133 randomly plays the subset of the video playlist on a screen that is available and unused by the transaction interface associated with transaction manager 123 or retail shopping app 133.

The subset of the video playlist includes the suggested additional product codes provided by the recommendation service 143. However, the videos 118 played to the customer during the checkout are relevant to a persona that is linked to the customer; a persona the customer likes. For example, if the customer likes dogs, the video played can be of a dog within the context of one or more of the suggested additional products provided by the recommendation service 143.

System 100 permits targeted video advertisements that are within the context of and relevant to the preferred tastes and likes of the customer to be played during a checkout with suggested products visually presented within the video advertisement. The targeted video advertisement is presented within a separate interface screen so as to not interfere with a transaction interface screen that the customer is interacting with during the checkout. In an embodiment, the transaction manager 123 provides an identifier or a location for the separate interface screen which plays the targeted video advertisement to video manager 124. In an embodiment, the operations of the video manager 124 is subsumed into the transaction manager 123 and retail shopping app 133.

FIG. 1B is an entity relationship diagram 150 for persona-based content rendering to a customer during a checkout, according to an example embodiment. Again, entity relationship diagram 150 is shown in greatly simplified form with only those components necessary for comprehending the teachings presented herein illustrated.

At 150-1, system 100 includes a library or data store of product advertisement videos 118. At 150-2, video object indexer 115 obtains each frame of each video 118. At 150-3, video object indexer 115 stores in storage, cache, and/or memory the images frames per video 118. At 150-4, video object indexer 115 performs object detection. At 150-4-1, video object indexer 115 provides each frame of each video 118 with the corresponding bounding boxes to a product recognition algorithm or recognizer, at 150-4-2. At 150-4-3, video object indexer 115 links product barcodes or GTINs to the products recognized in each video 118.

At 150-5, each individual non-product object in each frame has a bounding box correlated with it and occurrences of each unique object from frame to frame of a given video are counted. At 150-6, video object indexer 115 tags the unique non-product objects; the video object indexer 115 generates or creates tag histogram(s). For example, for each video a histogram is created for the unique product objects or codes assigned GTIN tags and another histogram is created for non-product objects. The histogram(s) include(s) a unique identifier or tag for the object (i.e., product and non-product objects) and a frequency count indicating how many occurrences of a given object appears in the frames of a given video 118.

At 150-7, persona matcher 116 assigns predefined personas to each of the videos 118 using the corresponding histogram(s) for the product objects and non-product objects. This can be done in any of the manners discussed above with FIG. 1A. At 150-8, persona matcher 116 assigns persona tags or identifiers to the videos 118.

Separately and/or concurrently to what was discussed above, a UI of a loyalty system 114 captures personas of customers. This includes the likes and dislikes of the customers. The interests, personas, likes, and dislikes are associated with each customer in a loyalty records associated with each customer's loyalty account with the loyalty system 114.

At 150-11, transaction manager 123 or retail shopping app 133 receives loyalty data of a customer checkout out with products during a transaction. At 150-11-1, transaction system 113 links the loyalty data entered or received from the customer to the personas associated with the customer's loyalty account through a customer data manager of transaction system 113. At 150-11-2, transaction system 113 retrieves the personas linked to the customer via 150-9.

At 150-12, transaction system 113 provides a product catalog 117 and a loyalty profile for the customer, to a recommendation service 143. At 150-13, transaction system 113 receives back from the recommendation service 143 suggested products that the customer is amenable or likely to also purchase during the checkout. At 150-14, the transaction system 113 matches the suggested products to in-store product barcodes and product information. At 150-15, persona matcher 116 generates a first list of advertisement videos 118 that include the suggested products provided by the recommendation service. At 150-10, persona matcher 116 obtains an initial persona playlist of advertisement videos 118 linked to the customer who is performing the checkout.

At 150-16, persona matcher 116 filters the customers persona video playlist on the list of available advertisement videos 118 which include one or more of the suggested products provided by the recommendation service 143 to overlap the suggested products with the personas of the customer. Persona matcher 116 creates a video playlist, at 150-17, the video playlist for the checkout includes the suggested products visually presented within a given video 118 of the playlist in the context or relevant to the personas of the customer.

Persona matcher 116 streams or sends the videos 118 of the shopping video playlist in any order or random order to transaction manager 123, video manager 124, and/or retail shopping app 133. Each video is played within a transaction interface screen that is available and unused during the transaction associated with the customer's checkout. This can be done in any of the manners discussed above with FIG. 1A.

FIG. 1C is a graphic depicting persona-based content rendering 160 during a checkout, according to an embodiment. FIG. 1C presents about visual depiction of system 100.

At 160-1, a customer or a clerk on behalf of the customer initiates a checkout process or a checkout transaction on a terminal 120 or a user device 130. The transaction manager 123, transaction system 113, and/or retail shopping app 133 receives, at 160-1-1, loyalty data and/or biometrics that can be hashed to a loyalty account of the customer with a loyalty system 114. At 1602-1-2 and 160-1-3, the interests of the customer are obtained based on the customer's loyalty account or loyalty profile.

At 160-4, the transaction system 113 provides the interests as personas of the customer to persona matcher 116. At 160-2, a recommendation service 143 was called based on a loyalty profile of the customer; the loyalty profile including the customer's transaction history. At 160-2-1, the recommendation service 143 or engine returns or provides recommended or suggested products to persona matcher 116 or to transaction system 113, which provides to persona matcher 116.

At 160-5, persona matcher 116 utilizes the product codes for the recommended products and the personas linked to the customer to filter an advertisement video archive for videos 118, which include the product codes and within a context or relevant to the personas of the customer. At 160-6, persona matcher 116 dynamically generates and creates a persona-based playlist of videos 118, which include the recommended products and are visually presented within the context of or relevant to the customer's personas.

In an embodiment, persona matcher 116, scores the videos 118 in the playlist and puts the videos 118 in a priority order. Persona matcher 116 streams or provides one or more of the top priority videos 118 to transaction manager 123, video manager 124, or retail shopping app 133 for presentation on a screen of a display associated with terminal 120 or user device 130 during the checkout process to the customer. The screen that the video is played within is a screen that is not being used by the transaction interface for the checkout process.

In an embodiment, persona matcher 116 randomly or provides one or more of the videos 118 from the playlist to transaction manager 123, video manager 124, or retail shopping app 133 for presentation on a screen of a display associated with terminal 120 or user device 130 during the checkout process to the customer. The screen that the video is played within is a screen that is not being used by the transaction interface for the checkout process.

In an embodiment, the screen that the video is played within includes overlayed text and/or embedded links, which when selected by the customer causes the product code associated with the video to be provided to transaction manager 123 or retail shopping app 133. A checkout or transaction workflow is interrupted based on the customer-activated link and the transaction UI asks the customer if the customer wants to add the product to the checkout process. The text and/or embedded links can also include detailed product information, such as product description, product weight, product dimensions, product nutritional information, product pricing, etc.

In an embodiment, the terminal 120 is a self-service (SST) terminal and the checkout is a self-checkout. In an embodiment, the terminal 120 is a point-of-sale (POS) terminal and the checkout is an attendant assisted checkout.

In an embodiment, the checkout is performed by the customer on a user device 130. The customer can be shopping online from any location or be shopping in a store while operating the user device 130.

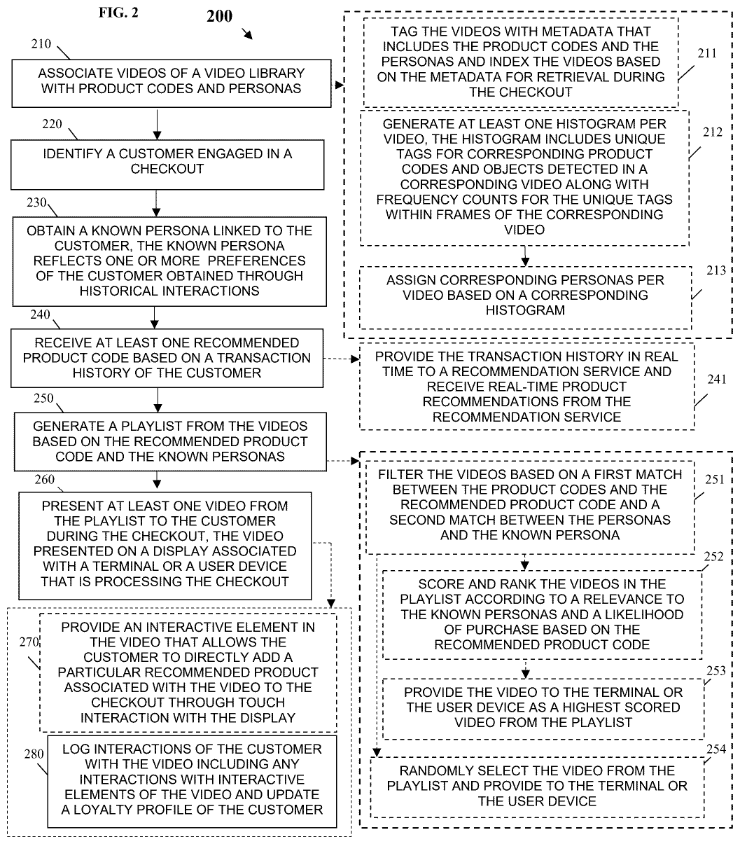

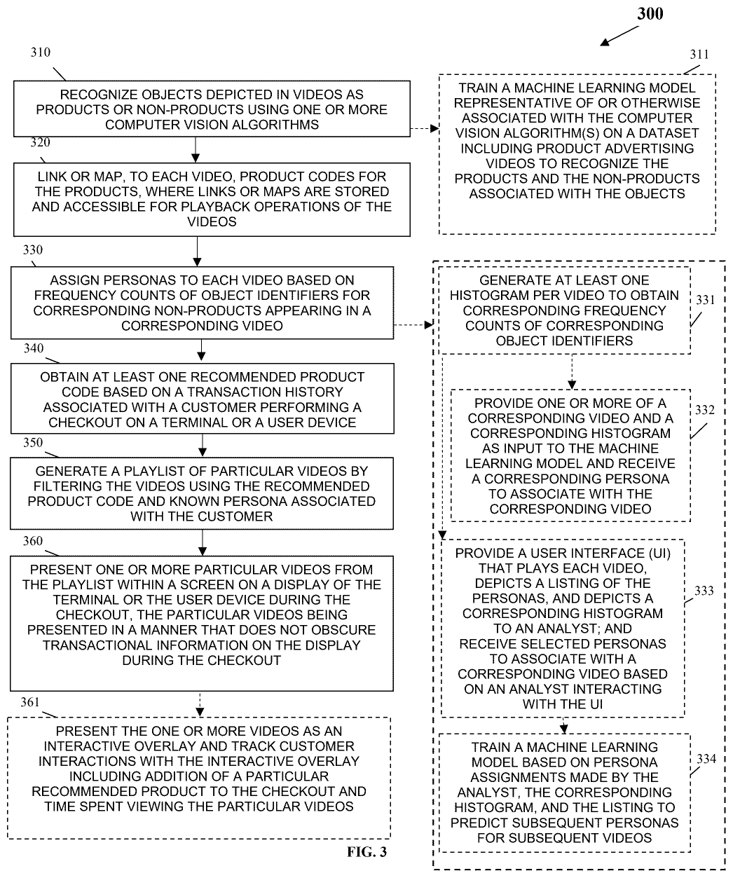

The above-referenced embodiments and other embodiments are now discussed with reference to FIGS. 2 and 3. FIG. 2 is a diagram of a method 200 for persona-based content rendering to a customer during a checkout, according to an example embodiment. The software module(s) that implements the method 200 is referred to as a “persona-based content renderer.” The persona-based content renderer is implemented as executable instructions programmed and residing within memory and/or a non-transitory computer-readable (processor-readable) storage medium and executed by one or more processors of one or more devices. The processor(s) of the device(s) that executes the persona-based content renderer are specifically configured and programmed to process the persona-based content renderer. The persona-based content renderer may have access to one or more network connections during its processing. The network connections can be wired, wireless, or a combination of wired and wireless.

In an embodiment, the device that executes the persona-based content renderer is cloud 110 or server 110. In an embodiment, the devices that execute the persona-based content renderer are cloud 110 and terminal 120. In an embodiment, the devices that execute the persona-based content renderer are cloud 110 and user device 130. In an embodiment, the persona-based content renderer is any combination of or all of transaction system 113, loyalty system 114, video object indexer 115, persona matcher 116, transaction manager 123, video manager 124, and/or retail shopping app 133.

At 210, persona-based content renderer associates videos 118 of a video library or datastore 150-1 with product codes and personas. That is, vision based algorithms are processed to recognizes product objects and recognize non-product objects in each frame of each video 118. Based on the frequencies or occurrences of the non-product objects within the frames of a given video 118, one or more personas are associated with the corresponding video 118.

In an embodiment, at 211, the persona-based content renderer tags the video 118 with metadata that includes the product codes and the personas. The persona-based content renderer indexes the videos 118 based on the metadata for retrieval during the checkout.

In an embodiment, at 212, the persona-based content renderer generates at least one histogram per video 118. The histogram includes unique tags for corresponding product codes and objects detected in a corresponding video 118 along with frequency counts for the unique tags within frames of the corresponding video 118. In an embodiment of 212 and at 213, the persona-based content renderer assigns corresponding personas per video 118 based on a corresponding video 118.

At 220, the persona-based content renderer identifies a customer engaged in a checkout. This can be done in a number of manners, through biometric recognition; through a loyalty card scanned, swiped, or inserted into a card reader; and/or through the customer entering a loyalty identifier or loyalty account number through a touch display of a terminal 120 or a user device 130.

At 230, the persona-based content renderer obtains at least one known persona linked to the customer. The known persona reflects one or more preferences (i.e., likes, dislikes, interests, disinterests, etc.) of the customer obtained through historical interactions with the customer.

At 240, the persona-based content renderer receives at least one recommended product code based on a transaction history of the customer. In an embodiment, at 241, the persona-based content renderer provides the transaction history in real time to a recommendation service and receives real-time product recommendations from a recommendation service 143.

At 250, the persona-based content renderer generates a playlist from the videos 118 based on the recommended product code(s) and the known persona. In an embodiment, at 251, the persona-based content renderer filters the videos 118 on a first match between the product codes and the recommended product code(s) and a second match between the personas and the known persona.

In an embodiment of 251 and at 252, the persona-based content renderer scores and ranks the videos 118 in the playlist according to a relevance to the known persona and a likelihood of purchase based on the recommended product code(s). In an embodiment of 252 and at 253, the persona-based content renderer provides the video 118 to the terminal 120 or the user device 130 as a highest scored video 118 from the playlist. In an embodiment of 251 and 252, at 254, the persona-based content renderer randomly selects the video 118 from the playlist and provides to the terminal 120 or the user device 130.

At 260, the persona-based content renderer presents at least one video 118 to the customer during the checkout. The video 118 presented on a display associated with a terminal 120 or the user device 130 that is processing the checkout.

In an embodiment, at 270, the persona-based content renderer provides an interactive element in the video 118 that allows the customer to directly add a particular recommended product associated with the video 118 to the checkout through touch interaction with the display. In an embodiment, the interactive element is an embedded link or links activated when the customer touches a visual depiction of the particular recommended product within the video 118 being played. In an embodiment, the interactive element is a graphic or text superimposed over or adjacent to the video and associated with an embedded action or link to add the particular recommended product to the checkout transaction.

In an embodiment, at 280, the persona-based content renderer logs interactions of the customer with the video 118. This includes any interactions with interactive elements of the video 118. The persona-based content renderer also updates a loyalty profile of the customer based on the interactions with the interactive elements of the video 118.

FIG. 3 is a diagram of another method 300 for persona-based content rendering to a customer during a checkout, according to an example embodiment. The software module(s) that implements the method 300 is referred to as a “checkout content manager.” The checkout content manager is implemented as executable instructions programmed and residing within memory and/or a non-transitory computer-readable (processor-readable) storage medium and executed by one or more processors of one or more device(s). The processors that execute the checkout content manager are specifically configured and programmed for processing the checkout content manager. The checkout content manager may have access to one or more network connections during its processing. The network connections can be wired, wireless, or a combination of wired and wireless.

In an embodiment, the device that executes checkout content manager is cloud 110 or server 110. In an embodiment, the devices that execute the checkout content manager are cloud 110 and terminal 120. In an embodiment, the devices that execute the checkout content manager are cloud 110 and user device 130. In an embodiment, the checkout content manager is any combination of or all of transaction system 113, loyalty system 114, video object indexer 115, persona matcher 116, transaction manager 123, video manager 124, retail shopping app 133, and/or method 200. The checkout content manager presents another and, in some ways, enhanced processing perspective from that which was discussed above for the system 100 of FIG. 1A, the entity relationship diagram 150 for persona-based content rendering of FIG. 1B, and/or the graphic depicting persona-based content rendering 160 of FIG. 1C.

At 310, the checkout content manager recognizes objects depicted in videos for products and non-products using one or more computer vision algorithms. In an embodiment, at 311, the checkout content manager trains a machine learning model representative of or otherwise associated with the computer vision algorithms on a dataset including product advertising videos 118 to recognize the products and the non-products associated with the objects.

At 320, the checkout content manager links or maps, to each video 118, product codes for the products. Links or maps are stored and are accessible for playback operations of the videos 118.

At 330, the checkout content manager assigns personas to each video 118 based on frequency counts of object identifiers for corresponding non-products appearing in a corresponding video. In an embodiment, at 331, the checkout content manager generates at least one histogram per video 118 to obtain corresponding frequency counts of corresponding object identifiers.

In an embodiment of 331 and at 332, the checkout content manager provides one or more of a corresponding video 118 and a corresponding histogram as input to a machine learning model. The checkout content manager receives as output from the machine learning model a corresponding persona or corresponding personas that are to be associated with the corresponding video 118.

In an embodiment of 331 and at 333, the checkout content manager provides a user interface (UI) that plays each video 118, depicts a listing of the personas, and depicts a corresponding histogram to an analyst. The checkout content manager receives selected personas to be associated with a corresponding video 118 based on an analyst interacting with the UI. In an embodiment of 333 and at 334, the checkout content manager trains a machine learning model based on persona assignments made by the analyst, the corresponding histogram, and the listing to predict subsequent personas for subsequent videos 118.

At 340, the checkout content manager obtains at least one recommended product code based on a transaction history associated with a customer who is performing a checkout on a terminal 120 or a user device 130. In an embodiment, a loyalty profile at least including the transaction history and a product catalog 117 are provided to a recommendation service 143 and the recommendation service 143 returns the recommended product codes.

At 350, the checkout content manager generates a playlist of particular videos 118 using the recommended product code(s) and the known persona associated with the customer. The checkout content manager filters for videos 118 that both match one or more of the recommended product codes and one or more of the customer's known personas to generate the playlist.

At 360, the checkout content manager presents one or more particular videos 118 from the playlist within a screen on a display of the terminal 120 or the user device 130 during the checkout. The particular videos being presented in a manner that does not obscure transactional information on the display during the checkout.

In an embodiment, at 361, the checkout content manager presents the one or more videos as an interactive overlay and track customer interactions with the interactive overlay. These interactions include adding a particular recommended product to the checkout and time spent by the customer viewing the particular videos 118.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
associating videos of a video library with product codes and personas;
identifying a customer engaged in a checkout;
obtaining a known persona linked to the customer, wherein the known persona reflects one or more preferences of the customer obtained through historical interactions with the customer;
receiving at least one recommended product code based on a transaction history of the customer;
generating a playlist from the videos based on the at least one recommended product code and the known persona; and
presenting at least one video from the playlist to the customer during the checkout, wherein the at least one video is presented on a display associated with a terminal or a user device that is processing the checkout.

2. The method of claim 1, wherein associating further includes tagging the videos with metadata that includes the product codes and the personas and indexing the videos based on the metadata for retrieval during the checkout.

3. The method of claim 1, wherein associating further includes generating at least one histogram per video, wherein the at least one histogram includes unique tags for corresponding product codes and objects detected in a corresponding video along with frequency counts for the unique tags within frames of the corresponding video.

4. The method of claim 3, wherein generating the at least one histogram per video further includes assigning corresponding personas per video based on a corresponding at least one histogram.

5. The method of claim 1, wherein receiving further includes providing the transaction history in real time to a recommendation service and receiving real-time recommended product recommendations from the recommendation service during the checkout.

6. The method of claim 1, wherein generating further includes filtering the videos based on a first match between the product codes and the at least one recommended product code and a second match between the personas and the known persona.

7. The method of claim 6, wherein filtering further includes scoring and ranking the videos in the playlist according a relevance to the known persona and a likelihood of purchase based on the at least one recommended product code.

8. The method of claim 7, wherein scoring further includes providing the at least one video to the terminal or the user device as a highest scored video from the playlist.

9. The method of claim 6, wherein filtering further includes randomly selecting the at least one video from the playlist and providing to the terminal or the user device.

10. The method of claim 1 further comprising, providing an interactive element in the at least one video that allows the customer to directly add a particular recommended product associated with the at least one video to the checkout through touch interaction with the display.

11. The method of claim 1 further comprising, logging interactions of the customer with the at least one video including any interactions with interactive elements of the at least one video and updating a loyalty profile associated with the customer based on the interactions.

12. A method, comprising:
recognizing objects depicted in videos for products or non-products using one or more computer vision algorithms;
linking or mapping, to each video, product codes for the products, wherein links or maps are stored and accessible for playback operations of the videos;
assigning personas to each video based on frequency counts of object identifiers for corresponding non-products appearing in a corresponding video;
obtaining at least one recommended product code based on a transaction history associated with a customer who is performing a checkout on a terminal or on a user device;
generating a playlist of particular videos by filtering the videos using the at least one recommended product code and a known persona associated with the customer; and
presenting one or more of the particular videos from the playlist within a screen on a display of the terminal or of the user device during the checkout, wherein the one or more of the particular videos being presented in a manner that does not obscure transactional information on the display during the checkout.

13. The method of claim 12, wherein recognizing further includes training a machine learning model representative of or otherwise associated with the computer vision algorithms to recognize the products and the non-products associated with the objects.

14. The method of claim 12, wherein assigning further includes generating at least one histogram per video to obtain corresponding frequency counts of corresponding object identifiers.

15. The method of claim 14, wherein generating the at least one histogram further includes providing one or more of a corresponding video and a corresponding at least one histogram as input to a machine learning model and receiving a corresponding persona to associate with the corresponding video.

16. The method of claim 14 further comprising:
providing a user interface (UI) that plays each video, depicts a listing of the personas, and depicts a corresponding at least one histogram to an analyst; and
receiving one or more selected personas to associate with a corresponding video based on an analyst interacting with the UI.

17. The method of claim 16 further comprising, training a machine learning model based on persona assignments made by the analyst, the corresponding at least one histogram, and the listing of the personas to predict subsequent personas for subsequent videos without interaction of the analyst.

18. The method of claim 12, wherein presenting further includes providing the one or more videos as an interactive overlay and track customer interactions with the interactive overlay including adding a particular recommended product to the checkout and time spent viewing one or more of the particular videos.

19. A system, comprising: at least one processor and a non-transitory computer-readable storage medium;
the non-transitory computer-readable storage medium comprises executable instructions; and
the executable instructions when executed by the at least one processor cause the at least one processor to perform operations comprising:
maintaining a video library tagged with metadata associated with personas and product codes;
associating a customer engaged in a checkout on a terminal or on a user device with a loyalty account of a loyalty system;
obtaining a loyalty profile including a transaction history from the loyalty system using the loyalty account;
providing at least the transaction history to a recommendation service;
receiving at least one recommended product code from the recommendation service;
generating a playlist of one or more videos from the video library by matching the metadata to the at least one recommended product code and a known persona associated with the loyalty account of the customer;
selecting a particular video from the playlist; and
playing the particular video on a display of the terminal or the user device during the checkout without obscuring transactional information being presented within a transaction user interface on the display to the customer during the checkout.

20. The system of claim 19, wherein the terminal is a self-service terminal (SST), and the checkout is a self-checkout, or the terminal is a point-of-sale (POS) terminal, and the checkout is an attendant assisted checkout.
